(19) United States
(12) Patent Application Publication
(10) Pub. No.: US 2024/0111591 A1
(43) Pub. Date: Apr. 4, 2024

(54) Executing Kernel Workgroups Across Multiple Compute Unit Types

(71) Applicant: Advanced Micro Devices, Inc., Santa Clara, CA (US)

(72) Inventors: Bradford Michael Beckmann, Kirkland, WA (US); Sooraj Puthoor, Austin, TX (US)

(73) Assignee: Advanced Micro Devices, Inc., Santa Clara, CA (US)

(21) Appl. No.: 17/957,907

(22) Filed: Sep. 30, 2022

(51) Int. Cl. G06F 9/50; G06F 9/30

(52) U.S. Cl. CPC G06F 9/5038; G06F 9/3009; G06F 9/5072

(57) ABSTRACT

Portions of programs, oftentimes referred to as kernels, are written by programmers to target a particular type of compute unit, such as a central processing unit (CPU) core or a graphics processing unit (GPU) core. When executing a kernel, the kernel is separated into multiple parts referred to as workgroups, and each workgroup is provided to a compute unit for execution. Usage of one type of compute unit is monitored and, in response to the one type of compute unit being idle, one or more workgroups targeting another type of compute unit are executed on the one type of compute unit. For example, usage of CPU cores is monitored, and in response to the CPU cores being idle, one or more workgroups targeting GPU cores are executed on the CPU cores.

### GOVERNMENT LICENSE RIGHTS

This invention was made with government support under Agreement No. H98230-22-3-0001 awarded by the Maryland Procurement Office. The government has certain rights in the invention.

### BACKGROUND

Modern computing devices include any of various different components, such as central processing unit (CPU) cores, graphics processing unit (GPU) cores, memory, and so forth. Programmers are thus able to write code for execution on the CPU cores and write code for execution on the GPU cores.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a non-limiting example system that is operable to employ the executing kernel workgroups across multiple compute unit types described herein.

FIG. 2 is an example of a system architecture that is operable to employ the executing kernel workgroups across multiple compute unit types described herein.

FIG. 3 is another example of a system architecture that is operable to employ the executing kernel workgroups across multiple compute unit types described herein.

FIG. 4 is an example of a parallel accelerated processor chiplet that supports the executing kernel workgroups across multiple compute unit types described herein.

FIG. 5 is another example of a system architecture that is operable to employ the executing kernel workgroups across multiple compute unit types described herein.

FIG. 6 is a flow diagram depicting a procedure in an example implementation of default boost mode state for devices.

### DETAILED DESCRIPTION

### Overview

Computing devices include various types of components, such as CPUs, GPUs, memory, and so forth. Portions of programs, oftentimes referred to as kernels, are written by programmers to target a particular type of compute unit, such as a CPU core or a GPU core. When executing a kernel, the kernel is separated into multiple parts referred to as workgroups, and each workgroup is provided to a compute unit (e.g., a CPU core or GPU core) for execution. The techniques discussed herein allow usage of one type of compute unit to be monitored and, in response to the one type of compute unit being idle, one or more workgroups targeting another type of compute unit are executed on the one type of compute unit. For example, usage of CPU cores is monitored, and in response to the CPU cores being idle, one or more workgroups targeting GPU cores are executed on the CPU cores.

Using the techniques discussed herein, compute units that would otherwise be idle are used to execute part of the kernel. This allows execution of the kernel to be completed more quickly.

In some aspects, the techniques described herein relate to a method including: identifying a workgroup of a kernel on a computing device, the workgroup targeting execution on a compute unit of a first type of compute units of the computing device, and communicating an indication of the workgroup to a compute unit of a second type of compute units of the computing device for execution of the workgroup on the compute unit of the second type of compute units rather than on the compute unit of the first type of compute units.

In some aspects, the techniques described herein relate to a method, wherein the workgroup includes multiple threads of the kernel.

In some aspects, the techniques described herein relate to a method, wherein each compute unit of the first type of compute units is a graphics processing unit core and each compute unit of the second type of compute units is a central processing unit core.

In some aspects, the techniques described herein relate to a method, further including: identifying when the compute unit of the second type of compute units is idle, and executing, in response to identifying that the compute unit of the second type of compute units is idle, the workgroup on the compute unit of the second type of compute units of the computing device rather than on the compute unit of the first type of compute units.

In some aspects, the techniques described herein relate to a method, further including receiving a request from the compute unit of the second type of compute units, the request including a request to execute a workgroup, and wherein the identifying of the workgroup is in response to the request.

In some aspects, the techniques described herein relate to a method, further including: receiving a request from one compute unit of the second type of compute units, the request including a request to execute at least one workgroup, and communicating a rejection response to the one compute unit.

In some aspects, the techniques described herein relate to a method, wherein the first type of compute units and the second type of compute units are included on an accelerated processing unit.

In some aspects, the techniques described herein relate to a system including: a front end processing core to identify a workgroup of a kernel on a computing device that includes the system, the workgroup targeting execution on a compute unit of a first type of compute units of the computing device, and a synchronization module to communicate an indication of the workgroup to a compute unit of a second type of compute units of the computing device for execution on the compute unit of the second type of compute units rather than on the compute unit of the first type of compute units.

In some aspects, the techniques described herein relate to a system, wherein the workgroup includes multiple threads of the kernel.

In some aspects, the techniques described herein relate to a system, wherein each compute unit of the first type of compute units is a graphics processing unit core and each compute unit of the second type of compute units is a central processing unit core.

In some aspects, the techniques described herein relate to a system, wherein the front end processing core is to identify the workgroup in response to receiving a request from the compute unit of the second type of compute units, the request including a request to execute a workgroup.

In some aspects, the techniques described herein relate to a system, wherein the front end processing core is further to: receive a request from one compute unit of the second type of compute units, the request including a request to execute at least one workgroup, and communicate, via the synchronization module, a rejection response to the one compute unit.

In some aspects, the techniques described herein relate to a system, wherein the system includes an accelerated processing unit.

In some aspects, the techniques described herein relate to a computing device including: a first set of compute units, a second set of compute units of a different type than the first set of compute units, a front end processing core to identify a workgroup of a kernel on the computing device, the workgroup targeting execution on a compute unit of the first set of compute units, and a synchronization module to communicate an indication of the workgroup to a compute unit of the second set of compute units for execution on the compute unit of the second set of compute units rather than on the compute unit of the first set of compute units.

In some aspects, the techniques described herein relate to a computing device, wherein the workgroup includes multiple threads of the kernel.

In some aspects, the techniques described herein relate to a computing device, wherein each compute unit in the first set of compute units is a graphics processing unit core and each compute unit in the second set of compute units is a central processing unit core.

In some aspects, the techniques described herein relate to a computing device, further including: an idle detection module to identify when the compute unit of the second set of compute units is idle, and wherein the compute unit of the second set of compute units is to execute, in response to identifying that the compute unit of the second set of compute units is idle, the workgroup on the compute unit of the second set of compute units rather than on the compute unit of the first set of compute units.

In some aspects, the techniques described herein relate to a computing device, wherein the front end processing core is to identify the workgroup in response to receiving a request from the compute unit of the second set of compute units, the request including a request to execute a workgroup.

In some aspects, the techniques described herein relate to a computing device, wherein the front end processing core is further to: receive a request from one compute unit of the second set of compute units, the request including a request to execute at least one workgroup, and communicate, via the synchronization module, a rejection response to the one compute unit.

In some aspects, the techniques described herein relate to a computing device, wherein the first set of compute units and the second set of compute units are included on an accelerated processing unit of the computing device.

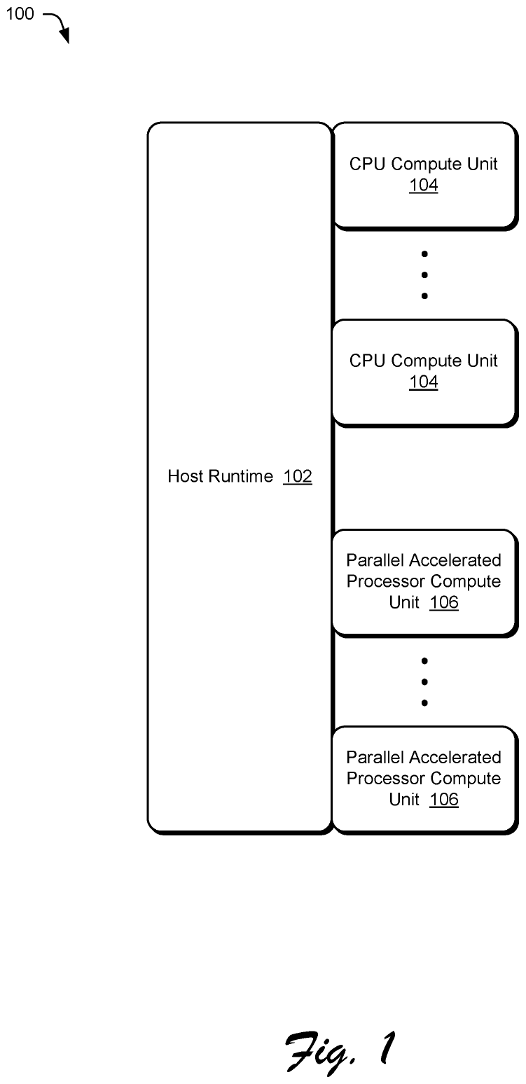

FIG. 1 is an illustration of a non-limiting example system 100 that is operable to employ the executing kernel workgroups across multiple compute unit types described herein. The system includes a host runtime 102, multiple CPU compute units 104, and multiple parallel accelerated processor compute units 106. These compute units are also referred to as cores. The multiple CPU compute units 104 are the same types of compute units or different types of compute units. Similarly, the multiple parallel accelerated processor compute units 106 are the same types of compute units or different types of compute units.

Each compute unit includes one or more of various different processing elements, such as arithmetic logic units (ALUs), floating-point units (FPUs), memory (e.g., caches), vector processors, registers, and so forth. Examples of compute units include CPU cores and GPU cores. Although multiple CPU compute units 104 and multiple parallel accelerated processor compute units 106 are illustrated, additionally or alternatively the system 100 includes one or both of a single CPU compute unit 104 or a single parallel accelerated processor compute unit 106.

The host runtime 102 is software or firmware, and optionally hardware, resources that allow one or more software programs (e.g., an application) to be run on a device implementing the system 100 (e.g., executed on the CPU compute units 104 and the parallel accelerated processor compute units 106). In one or more implementations, the host runtime 102 includes at least part of an operating system running on the device implementing the system 100.

The parallel accelerated processor compute units 106 are, for example, GPU cores. In one or more implementations, the CPU compute units 104 and the parallel accelerated processor compute units 106 are included on a single accelerated processing unit (APU) that includes multiple chiplets in a single package. A chiplet refers to different silicon dies mounted onto a substrate layer. For example, the APU includes multiple CPU chiplets (each of which includes multiple CPU compute units 104) and multiple parallel accelerated processor chiplets (each of which includes parallel accelerated processor compute units 106). Additionally or alternatively, the CPU compute units 104 and the parallel accelerated processor compute units 106 are implemented across multiple components (e.g., across multiple APUs).

Software programs oftentimes include multiple portions referred to as kernels. The kernels are written by programmers to target a particular type of compute unit, such as a CPU compute unit 104 or a parallel accelerated processor compute unit 106. E.g., the programmer intends the kernel to be executed on the particular type of compute unit. When executing a kernel, the kernel is separated into multiple parts referred to as workgroups (workgroups are also referred to as thread blocks), and each workgroup is provided to a compute unit (e.g., a CPU compute unit 104 or a parallel accelerated processor compute unit 106) for execution. In one or more implementations, each workgroup is a set of threads that are a subset of the kernel and that all execute on a single compute unit.

Although kernels are typically written by programmers to target or be executed by a particular type of compute unit, when the programs are compiled the compiler is able to generate kernel binaries appropriate for different types of compute units. In one or more implementations, the compiler (e.g., an LLVM compiler) compiles a program into an intermediate representation (IR) that is architecture independent. The compiler backend then compiles the IR and generates binaries or assembly code for different types of compute units (e.g., a CPU or a parallel accelerated processor). For a given kernel, the compiler or compiler backend generates a unique kernel “code object” for each compute unit given the synchronization features of the compute unit, the instruction set architecture (ISA) of the compute unit, and so forth. Accordingly, different workgroups of a program are able to be executed on different types of compute units. For example, workgroups for a program targeting or expected to be executed by the parallel accelerated processor compute units 106 are able to be executed by the CPU compute units 104.

As discussed in more detail below, the techniques described herein allow, in response to one type of compute unit being idle, one or more workgroups targeting another type of compute unit being executed on the one type of compute unit. For example, in response to a CPU core compute unit being idle, one or more workgroups targeting the parallel accelerated processor compute units 106 are executed on the CPU compute unit 104 that would otherwise be idle.

Although reference is made herein to CPU compute units and parallel accelerated processor compute units, it is to be appreciated that various other types of compute units are additionally or alternatively usable in the system 100. Examples of additional compute units include field-programmable gate arrays (FPGAs), application-specific integrated circuits (ASICs), and so forth.

The system 100 is implementable in any of a variety of different types of computing devices. For example, the system 100 is implementable in a server device, a desktop computer, a laptop computer, a smartphone or other wireless phone, a tablet or phablet computer, a notebook computer (e.g., netbook or ultrabook), a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television), an Internet of Things (IoT) device, an automotive computer, and so forth.

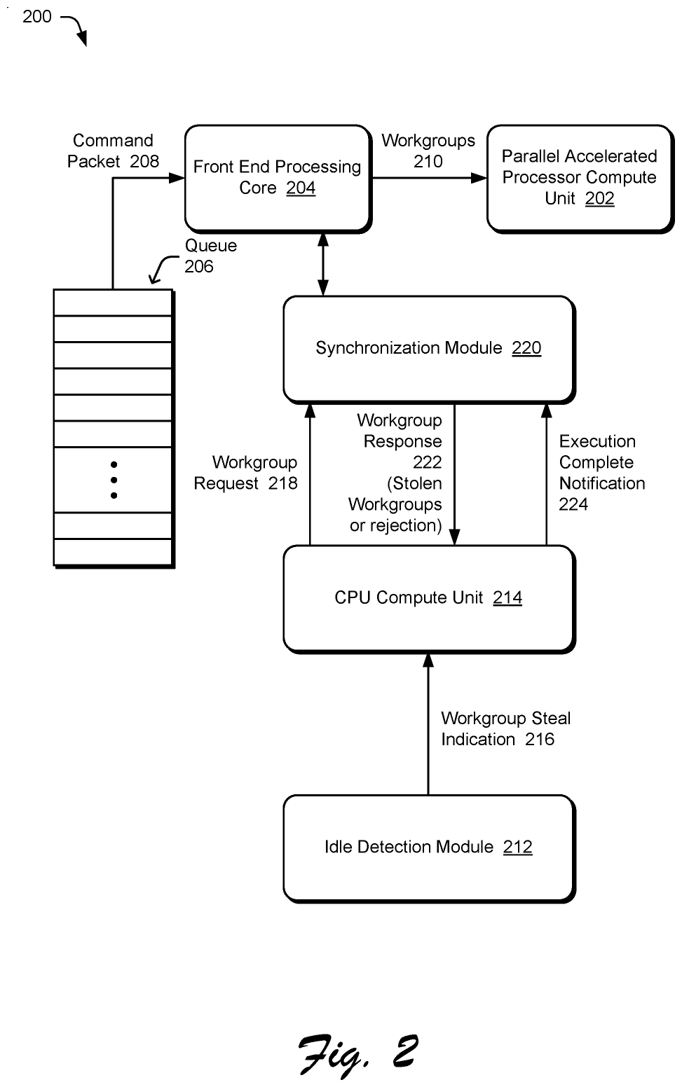

FIG. 2 is an example of a system architecture 200 that is operable to employ the executing kernel workgroups across multiple compute unit types described herein. The system architecture 200 illustrates a parallel accelerated processor compute unit 202 (e.g., which in one or more implementations is a parallel accelerated processor compute unit 106 of FIG. 1) having an associated front end processing core 204.

Command packets identifying workgroups for a kernel targeting parallel accelerated compute units, including parallel accelerated processor compute unit 202, are loaded into a queue 206. The parallel accelerated processor compute unit 202 shares the queue 206 with other parallel accelerated processor compute units (not shown in FIG. 2). In one or more implementations, the command packets are placed in the queue 206 by, e.g., an operating system or by the host runtime 102. Additionally or alternatively, the command packets are placed in the queue 206 by a user application (e.g., an application running on the system 100), in which case the front end processing core 204 and the idle detection module 212 identify idle resources as discussed in more detail below.

For each command packet in the queue 206, the front end processing core 204 determines which workgroups in the command packet are to be executed by the parallel accelerated processor compute unit 202. This determination is made in any of a variety of different manners, such by the associated front end processing core 204 applying a predefined algorithm to determine which workgroups the parallel accelerated processor compute unit 202 is responsible to execute. For each command packet in the queue 206, the front end processing core 204 retrieves the command packet 208 from the queue 206, identifies the workgroups in the command packet 208, and provides the identified workgroups 210 to the parallel accelerated processor compute unit 202 for execution. Accordingly, the workgroups are statically assigned to the various parallel accelerated processor compute units.

An idle detection module 212 determines when a CPU compute unit 214 is idle. The idle detection module 212 is, for example, part of the host runtime 102 or an operating system. In one or more implementations, a CPU compute unit 214 being idle refers to the CPU compute unit 214 not executing any instructions (e.g., for at least a threshold number of cycles or amount of time). Additionally or alternatively, the CPU compute unit 214 being idle refers to the CPU compute unit 214 executing instructions at less than a maximum level the CPU compute unit 214 is able to, such as at less than a threshold rate (e.g., less than a threshold number of instructions per 100 milliseconds (ms)).

The idle detection module 212 determines whether the CPU compute unit 214 is idle in any of a variety of different manners. In one or more implementations, an operating system running on the device implementing the system architecture 200 exposes one or more application programming interfaces (APIs) that are invokable to receive information regarding the idleness of the CPU compute unit 214 (e.g., an indication whether the CPU compute unit 214 is idle or not idle, an indication of the rate at which the CPU compute unit 214 is executing instructions, and so forth). The idle detection module 212 invokes these one or more operating system APIs to determines whether the CPU compute unit 214 is idle. Additionally or alternatively, the idle detection module 212 determines whether the CPU compute unit 214 is idle based on a state the CPU compute unit 214 is in. E.g., if the CPU compute unit 214 is in a particular state (e.g., a C6 state), then the idle detection module 212 determines that the CPU compute unit 214 is idle.

In response to determining that the CPU compute unit 214 is idle, the idle detection module 212 provides, to the CPU compute unit 214, an indication to execute one or more workgroups targeted for the parallel accelerated processor compute unit 202. This indication is illustrated as a workgroup steal indication 216. In one or more implementations, the idle detection module 212 provides this indication by providing to the CPU compute unit 214 an indication of (e.g., pointer to) one or more threads that are to be executed by the CPU compute unit 214 to request one or more workgroups from the parallel accelerated processor compute unit 202.

The CPU compute unit 214 communicates a workgroup request 218 to a synchronization module 220 corresponding to the front end processing core 204. In response to the workgroup request, the front end processing core 204 identifies one or more workgroups for the CPU compute unit 214 to execute and responds to the workgroup request 218 via a workgroup response 222 from the synchronization module 220. The workgroup response 222 is an indication of the one or more workgroups identified by the front end processing core 204, also referred to as stolen workgroups. This indication takes any of various forms, such as an entry point or beginning address of each thread in the one or more workgroups identified by the front end processing core 204. The CPU compute unit 214 executes the stolen workgroups and upon completing execution returns, to indicate that the execution of the stolen workgroups has completed, an execution complete notification 224 to the front end processing core 204 via the synchronization module 220. This execution complete notification 224 is, for example, an indication to update or increment a counter (e.g., maintained by the synchronization module 220) of workgroups that have been completed. Accordingly, the front end processing core 204 knows the stolen workgroups have been executed and need not be executed by the parallel accelerated processor compute unit 202.

In one or more implementations, the command packet 208 includes a pointer to (e.g., a program counter for) the binary for the parallel accelerated processor compute unit 202 to execute and a binary for the CPU compute unit 214 to execute. Accordingly, the workgroup response 222 includes a pointer to at least one binary for the parallel accelerated processor compute unit 202 to execute for each stolen workgroup. For workgroups that are not stolen, the front end processing core 204 provides to the parallel accelerated processor compute unit 202 a pointer to at least one binary for the parallel accelerated processor compute unit 202 to execute.

This technique of having the CPU compute unit 214 execute one or more workgroups that targeted the parallel accelerated processor compute unit 202 is also referred to as the CPU compute unit 214 stealing the one or more workgroups from the parallel accelerated processor compute unit 202.

In one or more implementations, the front end processing core 204 maintains a list of workgroups for the parallel accelerated processor compute unit 202 to executed. The front end processing compute core 204 selects, as the stolen workgroups, workgroups that are on the opposite end of this list of workgroups from the workgroups 210. Accordingly, the parallel accelerated processor compute unit 202 and the CPU compute unit 214 are executing workgroups from opposite ends of this list of workgroups. For example, the front end processing core 204 provides workgroups 210 to the parallel accelerated processor compute unit 202 starting with a lowest numbered workgroup to a highest numbered workgroup, and selects as the stolen workgroups, workgroups starting with a highest numbered workgroup to a lowest numbered workgroup. This helps improve the effectiveness of having an idle CPU compute unit execute workgroups targeted for a parallel accelerated processor core, helping the front end processing core 204 keep the workgroups the parallel accelerated processor compute unit 202 is processing separate from the workgroups the CPU compute unit 214 is processing.

In one or more implementations, in response to the workgroup request 218, the front end processing core 204 need not identify one or more workgroups for the CPU compute unit 214 to execute. Rather, the front end processing core 204 returns, via the synchronization module 220, a workgroup response 222 rejecting the workgroup request 218 (e.g., a negative acknowledgement (NACK)). The front end processing core 204 uses any of a variety of techniques to determine whether to identify one or more workgroups for the CPU compute unit 214 to execute or reject the request. In one or more implementations, the front end processing core 204 determines whether to identify one or more workgroups for the CPU compute unit 214 to execute or reject the request based at least in part on one or both of a rate at which the parallel accelerated processor compute unit 202 is executing work groups and a number of workgroups remaining in the list of workgroups for the parallel accelerated processor compute unit 202 to execute. For example, if the parallel accelerated processor compute unit 202 is typically executing workgroups in less than a threshold amount of time (e.g., 100 ms) and there are fewer than a threshold number of workgroups remaining (e.g., 5), then the front end processing core 204 rejects the request (e.g., since the parallel accelerated processor compute unit 202 will finish executing the workgroups quick enough). However, if the parallel accelerated processor compute unit 202 is typically executing workgroups in greater than a threshold amount of time (e.g., 100 ms) or there are greater than a threshold number of workgroups remaining (e.g., 5), then the front end processing core 204 identifies one or more workgroups for the CPU compute unit 214 to execute.

It should be noted that implementing these techniques adds little to no extra overhead in situations in which no CPU compute units are detected idle. If no CPU compute units are detected idle, the workgroups targeting the parallel accelerated processor compute units are executed by the parallel accelerated processor compute units, the computing device effectively running the same as if the techniques discussed herein were not implemented in the computing device.

Although a single parallel accelerated processor compute unit 202 and a single CPU compute unit 214 are illustrated in FIG. 2, it is to be appreciated that any number of parallel accelerated processor compute units and any number of CPU compute units are usable with the techniques discussed herein. Any one or more of the CPU compute units are able to execute workgroups targeted for execution by any one or more of the parallel accelerated processor compute units. In one or more implementations, a bus (e.g., a command bus) is used to facilitate communication among the various CPU compute units and the various parallel accelerated processor compute units (e.g., via synchronization modules corresponding to the various parallel accelerated processor compute units) as discussed in more detail below.

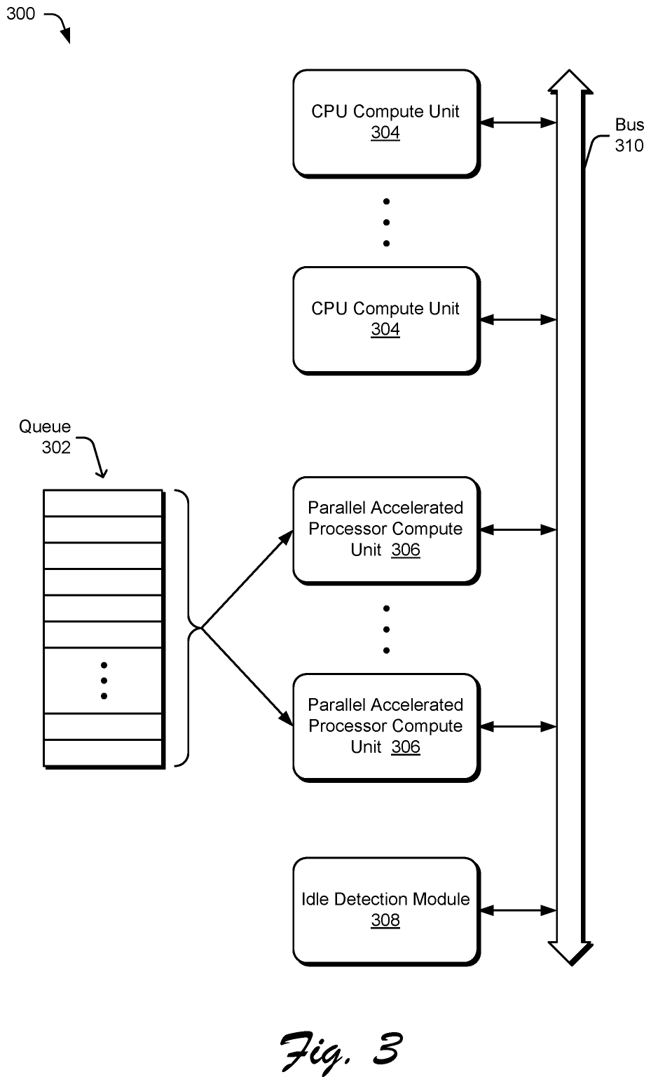

FIG. 3 is another example of a system architecture 300 that is operable to employ the executing kernel workgroups across multiple compute unit types described herein. The system architecture 300 illustrates a queue 302 (which in one or more implementations is the queue 206 of FIG. 2), multiple CPU compute units 304 (which in one or more implementations is the CPU compute units 104 of FIG. 1 or multiple ones of the CPU compute unit 214 of FIG. 2), multiple parallel accelerated processor compute units 306 (which in one or more implementations is the parallel accelerated processor compute units 106 of FIG. 1 or multiple ones of the parallel accelerated processor compute unit 202 of FIG. 2), an idle detection module 308 (which in one or more implementations is the idle detection module 212 of FIG. 2), and a bus 310.

Command packets identifying workgroups for a kernel targeting the parallel accelerated processor compute units 306 are loaded into the queue 302. The parallel accelerated processor compute units 306 share the queue 302, taking workgroups from command packets in the queue 302 for execution.

The CPU compute units 304, the parallel accelerated processor compute units 306, and the idle detection module 308 communicate with one another via a bus 310, such as a command network for distributed IP (CNDI) bus. The CPU compute units 304 use the bus 310 to request one or more workgroups from a parallel accelerated processor compute unit 306 and to send an indication that a CPU compute unit 304 has completed execution of a workgroup, such as by using memory-mapped input/output (MMIO) operations. Similarly, the parallel accelerated processor compute units 306 use the bus 310 to communicate workgroup responses to a requesting CPU compute unit 214 (e.g., an indication of one or more workgroups for the CPU compute unit 214 to execute or a NACK).

When stealing workgroups, which of the parallel accelerated processor compute units 306 the workgroups are to be stolen from for execution on a CPU compute unit 304 is determined in any of a variety of different manners. In one example, a list of the parallel accelerated processor compute units 306 is known and one of the parallel accelerated processor compute units 306 is selected in accordance with some rules or criteria (e.g., selected randomly). By way of another example, front end processing cores (e.g., which in one or more implementations is different front end processing cores 204 of FIG. 2) corresponding to each of the parallel accelerated processor compute units 306 communicate with one another (e.g., via the bus 310) to determine which is to provide one more workgroups to the CPU compute unit 304 for execution. This determination is based on various criteria, such as one or more of number of workgroups remaining for each parallel accelerated processor compute unit 306 to execute, amount of time execution of workgroups is taking for the different parallel accelerated processor compute units 306, and so forth.

In one or more implementations, multiple parallel accelerated processor compute units 306 are included on a single chiplet. Similarly, in one or more implementations multiple CPU compute units 304 are included on a single chiplet.

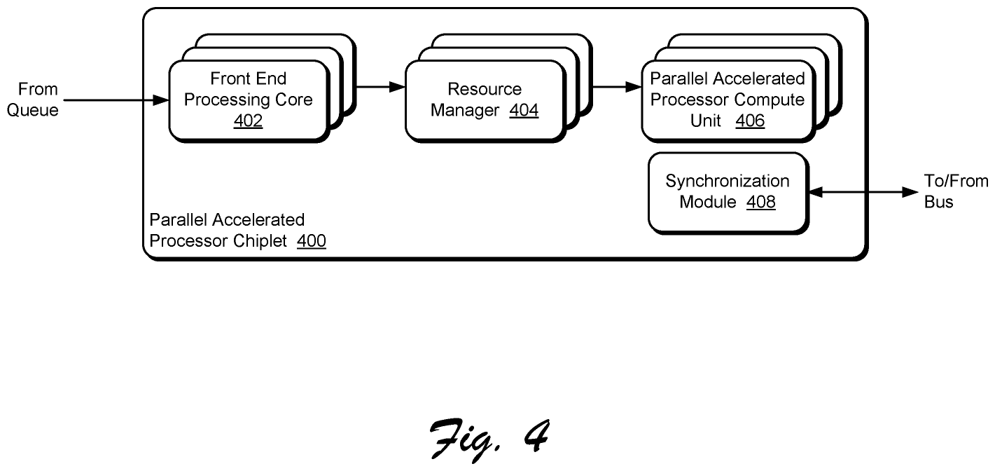

FIG. 4 is an example of a parallel accelerated processor chiplet 400 that supports the executing kernel workgroups across multiple compute unit types described herein. The chiplet 400 includes one or more front end processing cores 402, one or more resource managers 404, one or more parallel accelerated processor compute units 406, and a synchronization module 408. The front end processing core 402 (e.g., which in one or more implementations is the front end processing core 204 of FIG. 2) receives a command packet from a queue (e.g., the queue 206 of FIG. 2 or the queue 302 of FIG. 3). The front end processing core 402 parses the command packet received from the queue and determines the number of workgroups corresponding to the command packet and the sizes of those workgroups (e.g., the number of threads in those workgroups). The front end processing core 402 also generates the individual workgroups corresponding to the command packet and submits those workgroups to the resource managers 404.

The resource managers 404 track resources used in the parallel accelerated processor chiplet 400 and submits the various workgroups corresponding to the command packet to the different parallel accelerated processor compute units 406 based on this resource usage.

The synchronization module 408 (e.g., which in one or more implementations is a synchronization module 220 of FIG. 2) communicates with other chiplets via a bus, such as the bus 310 of FIG. 3). The synchronization module 408 receives requests for workgroups from CPU cores (e.g., situated on other chiplets (not shown in FIG. 4)), returns responses to requests for workgroups, receives indications of workgroup completion, updates a counter of completed workgroups, and so forth.

In the discussions above, particularly with reference to FIG. 2 and FIG. 3, a single queue that provides command packets to multiple CPU cores and multiple parallel accelerated processor cores. Additionally or alternatively, rather than a single shared queue, in one or more implementations different cores (or collections of cores) have their own queues.

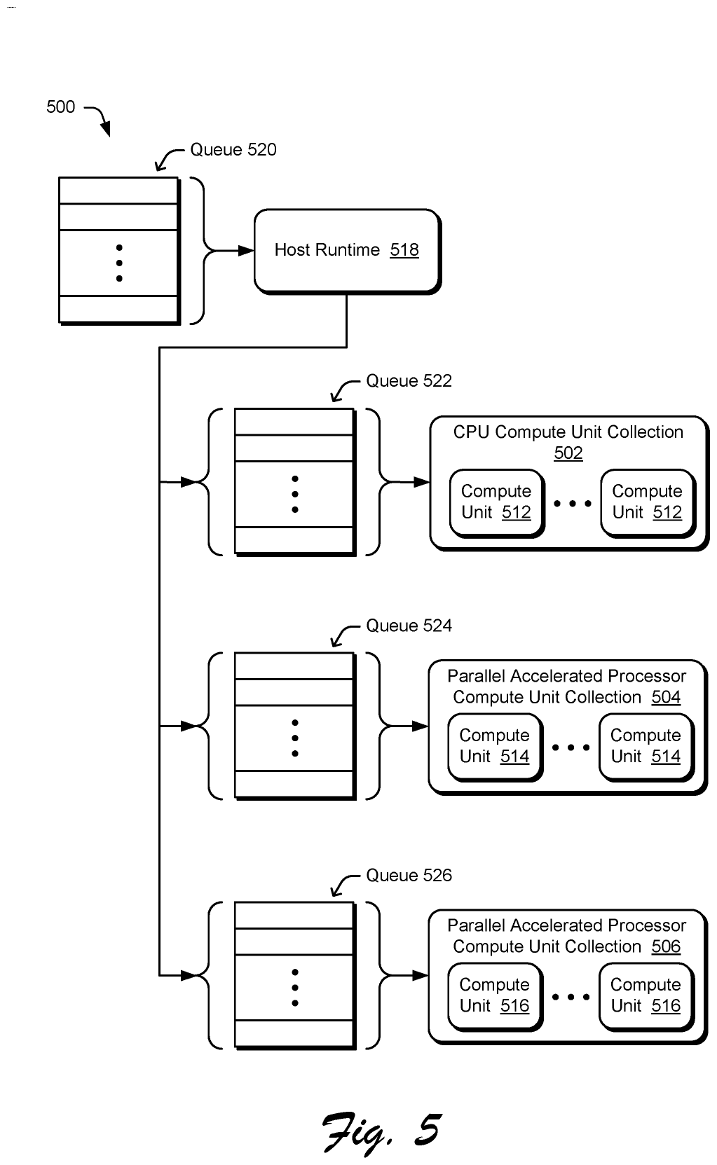

FIG. 5 is another example of a system architecture 500 that is operable to employ the executing kernel workgroups across multiple compute unit types described herein. The system architecture 500 illustrates multiple compute unit collections, including CPU compute unit collection 502, parallel accelerated processor compute unit collection 504, and parallel accelerated processor compute unit collection 506. The CPU compute unit collection 502 includes multiple compute units 512, the parallel accelerated processor compute unit collection 504 includes multiple compute units 514, and the parallel accelerated processor compute unit collection 506 includes multiple compute units 516. Although a limited number of compute unit collections is illustrated, it is to be appreciated that the architecture 500 supports any number of CPU compute unit collections (each having any number of compute units) and any number of parallel accelerated processor compute unit collections (each having any number of compute units).

The architecture 500 also includes a host runtime 518 (e.g., the host runtime 102 of FIG. 1) and a corresponding queue 520 that is exposed to an application (e.g., an application running on the system 100 of FIG. 1). The host runtime 102 processes workgroups put in the queue 520 by the application, and offloads certain sets of workgroups to the CPU compute unit collection 502, the parallel accelerated processor compute unit collection 504, or the parallel accelerated processor compute unit collection 506. The host runtime 102 offloads workgroups to the CPU compute unit collection 502 by placing the workgroups into a queue 522 associated with the CPU compute unit collection 502. The queue 522 is a software defined queue in memory that is directly consumed by the CPU work threads of the compute units 512. The host runtime 102 offloads workgroups to the parallel accelerated processor compute unit collection 504 by placing the workgroups into a queue 524 associated with the parallel accelerated processor compute unit collection 504. The queue 524 is, for example, a hardware queue. The host runtime 102 offloads workgroups to the parallel accelerated processor compute unit collection 506 by placing the workgroups into a queue 526 associated with the parallel accelerated processor compute unit collection 506. The queue 526 is, for example, a hardware queue.

The host runtime (e.g., host runtime 102 of FIG. 1) splits work to be done (e.g., a program to be run) across the compute unit collections 502, 504, and 506. The host runtime splits work to be done across the compute unit collections 502, 504, and 506 using any of a variety of public or proprietary techniques. For example, the host runtime splits work to be done across the compute unit collections 502, 504, and 506 based on the resources or capabilities of the individual compute unit collections 502, 504, and 506, based on expected execution times for the workgroups, and so forth.

The host runtime identifies workgroups to be executed for the kernel and generates one or more command packets identifying workgroups that those compute unit collections 502, 504, and 506 are to execute. The host runtime also adds these one or more command packets to the queues 522, 524, and 526. Each command packet also includes, for each of the compute unit collections 502, 504, and 506, an indication of which of the workgroups the compute unit collection is to execute.

The command packet indicates which compute unit collections 502, 504, and 506 are to execute which workgroups in any of a variety of different manners. In one or more implementations, the command packet includes a field, such as a start workgroup index (SWI) field that identifies which workgroup a compute unit collection 502, 504, or 506 is to begin executing. For example, assume that the host runtime determines that parallel accelerated processor compute unit collection 506 is to execute the first X workgroups, parallel accelerated processor compute unit collection 504 is to execute the next Y workgroups, and the CPU compute unit collection 502 is to execute the next Z workgroups. In this example, the SWI field for the command packet indicates that the parallel accelerated processor compute unit collection 506 is to begin executing at workgroup 0, the parallel accelerated processor compute unit collection 504 is to begin executing at workgroup X, and the CPU compute unit collection 502 is to begin executing at workgroup X+Y.

As discussed above, although kernels are typically written by programmers to target or be executed by a particular type of compute unit, when the kernels are compiled the compiler is able to generate kernel binaries appropriate for different types of compute units. For a given kernel, the compiler generates a unique kernel “code object” for each compute unit given the cache hierarchy and synchronization features of the compute unit, the ISA of the compute unit, and so forth. The host runtime adds to the command packet an indication of which binary to execute by a particular compute unit collection 502, 504, or 506. E.g., for a given workgroup, the command packet in queue 522 indicates a binary corresponding to compute units 512, the command packet in queue 524 indicates a binary corresponding to compute units 514, and the command packet in queue 526 indicates a binary corresponding to the compute units 516.

In one or more implementations, the command packet includes a packet header that identifies the command packet as being a particular type of command packet (e.g., a command packet that includes the SWI).

In one or more implementations, a front end unit of each of the compute unit collections 502, 504, and 506 executes only workgroups indicted by the command packet as to be executed by that compute unit collection 502, 504, or 506. For example, continuing with the example above using the SWI, the front end unit of parallel accelerated processor compute unit collection 504 only executes workgroups starting with the workgroup having workgroup identifier X and ending with the workgroup having workgroup identifier X+S, where S refers to the number of workgroups in the command packet.

Accordingly, rather than having a single queue shared by all of the compute units as illustrated in FIG. 3, in the architecture of FIG. 5 each compute unit collection (e.g., each chiplet) has its own corresponding queue.

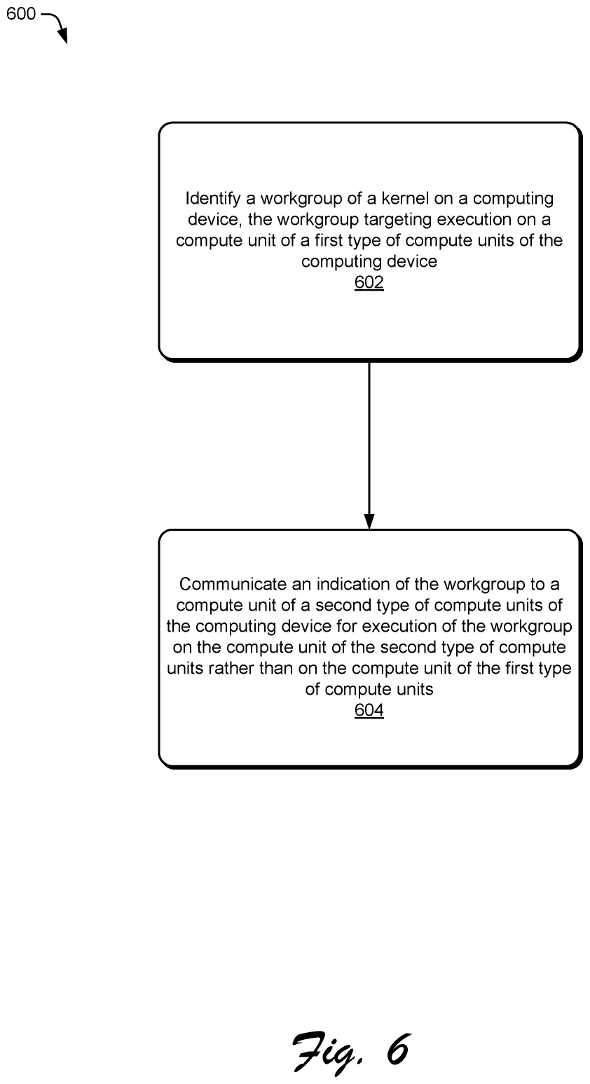

FIG. 6 is a flow diagram 600 depicting a procedure in an example implementation of default boost mode state for devices. The flow diagram 600 is performed by a front end processing core, such as front end processing core 204 of FIG. 2 or front end processing core 402 of FIG. 4.

In this example, a workgroup of a kernel on a computing device is identified (block 602). This workgroup is targeting execution on a first type of compute units of the computing device.

An indication of the workgroup is communicated to a compute unite of a second type of compute units of the computing device for execution of the workgroup on the compute unit of the second type of compute units rather than on the compute unit of the first type of compute units (block 604). Accordingly, the compute units are executed on a type of compute units other than the compute units on which execution of the one or more compute units was targeted.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the idle detection module 212, the synchronization module 220, the front end processing core 204, the front end processing core 402, the resource manager 404, and the synchronization module 408) are implemented in any of a variety of different manners such as hardware circuitry, software executing or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying a workgroup of a kernel on a computing device, the workgroup targeting execution on a compute unit of a first type of compute units of the computing device; and
communicating an indication of the workgroup to a compute unit of a second type of compute units of the computing device for execution of the workgroup on the compute unit of the second type of compute units rather than on the compute unit of the first type of compute units.

2. The method of claim 1, wherein the workgroup includes multiple threads of the kernel.

3. The method of claim 1, wherein each compute unit of the first type of compute units is a graphics processing unit core and each compute unit of the second type of compute units is a central processing unit core.

4. The method of claim 1, further comprising:
identifying when the compute unit of the second type of compute units is idle; and
executing, in response to identifying that the compute unit of the second type of compute units is idle, the workgroup on the compute unit of the second type of compute units of the computing device rather than on the compute unit of the first type of compute units.

5. The method of claim 1, further comprising receiving a request from the compute unit of the second type of compute units, the request comprising a request to execute a workgroup, and wherein the identifying of the workgroup is in response to the request.

6. The method of claim 1, further comprising:
receiving a request from one compute unit of the second type of compute units, the request comprising a request to execute at least one workgroup; and
communicating a rejection response to the one compute unit.

7. The method of claim 1, wherein the first type of compute units and the second type of compute units are included on an accelerated processing unit.

8. A system comprising:
a front end processing core to identify a workgroup of a kernel on a computing device that includes the system, the workgroup targeting execution on a compute unit of a first type of compute units of the computing device; and
a synchronization module to communicate an indication of the workgroup to a compute unit of a second type of compute units of the computing device for execution on the compute unit of the second type of compute units rather than on the compute unit of the first type of compute units.

9. The system of claim 8, wherein the workgroup includes multiple threads of the kernel.

10. The system of claim 8, wherein each compute unit of the first type of compute units is a graphics processing unit core and each compute unit of the second type of compute units is a central processing unit core.

11. The system of claim 8, wherein the front end processing core is to identify the workgroup in response to receiving a request from the compute unit of the second type of compute units, the request comprising a request to execute a workgroup.

12. The system of claim 8, wherein the front end processing core is further to:
receive a request from one compute unit of the second type of compute units, the request comprising a request to execute at least one workgroup; and
communicate, via the synchronization module, a rejection response to the one compute unit.

13. The system of claim 8, wherein the system comprises an accelerated processing unit.

14. A computing device comprising:
a first set of compute units;
a second set of compute units of a different type than the first set of compute units;
a front end processing core to identify a workgroup of a kernel on the computing device, the workgroup targeting execution on a compute unit of the first set of compute units; and
a synchronization module to communicate an indication of the workgroup to a compute unit of the second set of compute units for execution on the compute unit of the second set of compute units rather than on the compute unit of the first set of compute units.

15. The computing device of claim 14, wherein the workgroup includes multiple threads of the kernel.

16. The computing device of claim 14, wherein each compute unit in the first set of compute units is a graphics processing unit core and each compute unit in the second set of compute units is a central processing unit core.

17. The computing device of claim 14, further comprising:
an idle detection module to identify when the compute unit of the second set of compute units is idle; and
wherein the compute unit of the second set of compute units is to execute, in response to identifying that the compute unit of the second set of compute units is idle, the workgroup on the compute unit of the second set of compute units rather than on the compute unit of the first set of compute units.

18. The computing device of claim 14, wherein the front end processing core is to identify the workgroup in response to receiving a request from the compute unit of the second set of compute units, the request comprising a request to execute a workgroup.

19. The computing device of claim 14, wherein the front end processing core is further to:
receive a request from one compute unit of the second set of compute units, the request comprising a request to execute at least one workgroup; and
communicate, via the synchronization module, a rejection response to the one compute unit.

20. The computing device of claim 14, wherein the first set of compute units and the second set of compute units are included on an accelerated processing unit of the computing device.
